(19) United States
(12) Patent Application Publication
(10) Pub. No.: US 2022/0391722 A1
(43) Pub. Date: Dec. 8, 2022

(54) REDUCING IMPACT OF COLLECTING SYSTEM STATE INFORMATION

(71) Applicant: Dell Products L.P., Round Rock, TX (US)

(72) Inventors: Parminder Singh SETHI, Punjab (IN); Lakshmi S. NALAM, Bangalore (IN); Durai SINGH, Chennai (IN)

(73) Assignee: Dell Products L.P., Round Rock, TX (US)

(21) Appl. No.: 17/377,963

(22) Filed: Jul. 16, 2021

(30) Foreign Application Priority Data
Jun. 4, 2021 (IN) 202141024957

(51) Int. Cl. G06N 5/04; G06N 20/00

(52) U.S. Cl. CPC G06N 5/04; G06N 20/00

(57) ABSTRACT

A system and method intelligently collect performance data from managed electronic devices. A machine learning model (e.g. linear time series forecasting) is used to predict a future workload for each of a selection of devices, and a regression analysis is used to predict how long is likely to be required to collect performance state from each component of each device. These data are then mapped together to predict future overall idle periods of each device, together with components whose performance data may be collected during those periods. The components are grouped in batches according to a relevance order that itself may be determined by applying a machine learning model such as k-nearest neighbors. Then, performance data are collected according to the batches. In this way, performance data may be collected in chunks while avoiding a negative impact on execution of the primary functions of the managed devices.

### CROSS-REFERENCE TO RELATED APPLICATION

This application claims priority to Indian Provisional Patent Application 202141024957, filed Jun. 4, 2021 and naming the same inventors, the entire contents of which are incorporated herein by reference.

### FIELD

The disclosure pertains generally to the monitoring of electronic devices, and more particularly to scheduling the recording of device activity.

### BACKGROUND

Enterprise computing environments, such as environment 10 shown in FIG. 1, are known in the art. The environment 10 includes a management station 12 (i.e. a computer) for use by an information technology (IT) administrative professional to maximize IT productivity by monitoring and managing remote devices 16a, 16b to 16n (collectively, “remote devices”, “managed devices”, or “nodes” 16) using a common data network 14. Each of the remote devices 16 may be any sort of electronic device that can communicate performance data to the management station 12, including but not limited to computer servers, data storage systems, and networking devices, among other such devices known in the art.

The IT administrator's task of managing and monitoring remote devices is simplified using device management applications that execute on the management station 12. Device management applications collect system state information from the managed remote devices 16. Each collection of system state information contains the attributes of the various components of the remote device. For example, the collection from a server device may pertain to server components such as the processor, fan, memory, hard-drive, operating system, and so on. More concretely, the collection may include instrumentation telemetry data regarding processor utilization (e.g. as a percentage of its maximum), or fan temperature, or memory usage, or disk space available, or a number of concurrent processes executing, and so on.

A device management application may collect system state information from managed devices 16 at regular, periodic intervals. Periodic collection from all remote devices 16 is typically initiated by the management station 12 where the device management application is installed. The device management application typically provides administrators an option to schedule the periodic collection from remote devices 16 based on device type (for example, all servers in the environment, or just those running a particular operating system). In addition, the device management application may trigger a collection from a particular remote device when a critical alert is detected on that device. These regular (periodic) and emergent (alert-based) collections may be used by an IT helpdesk to troubleshoot and resolve problems that occur on the devices.

Existing device management applications may cause performance of the remote device to be negatively impacted by periodic collection of system state information. Before triggering a periodic collection, a device management application may determine the remote device type (e.g. “server”, “storage system”, or “networking device”) and subtype (e.g. for a server, what operating system or particular applications that server is executing). After determining the device type and subtype, the device management application may attempt to connect to the remote device using an appropriate protocol (e.g. Windows Management Instrumentation (WMI), or secure shell (SSH), or representational state transfer (REST) using Redfish). After the connection is established, the device management application runs various commands on the remote device to collect system state information. However, during this collection period, the remote device may be already running applications or tasks that consume significant computing resources, such as processors, central processing unit (CPU) clock cycles, storage input/output (I/O) operations, and so on. If collection of system state information is initiated when the workload of the device is high, the very act of collecting the instrumentation data will impact the performance of the remote device, delaying both collection of the data and the execution of those other applications.

Moreover, existing device management applications also suffer from limitations on the numbers of devices from which system state information can be simultaneously collected. Managed environments like environment 10 may have several thousands of remote devices 16 that require monitoring. But existing device management applications trigger periodic collection from only a fixed, limited number of devices (e.g. two or three nodes at a time) that represent only a very small fraction of the devices. After one periodic collection is complete, the device management application triggers another periodic collection from the next few devices, and this process repeats until state information has been collected from all remote devices 16. While this restriction efficiently collects data distributes workload across the management station 12 and the remote devices 16, it requires a great deal of time to sweep the entire managed environment 10 to collect state information from all remote devices 16. Moreover, information from some devices may be indefinitely delayed by this piecemeal approach, leading to an increased chance that the IT administrator will make management decisions based on outdated information.

### SUMMARY OF DISCLOSED EMBODIMENTS

Disclosed embodiments optimize periodic telemetry collections from remote devices by scheduling collections according to the predicted workload on those devices themselves. Various embodiments predict the workload of each remote device by analyzing its historical performance and its configuration data. Embodiments also predict the duration of time required to collect telemetry information from each component of the remote device, by analyzing the device configuration and historical collection durations. Embodiments then schedule periodic telemetry collections for individual components based on the idle times identified in the workload prediction.

In this way, embodiments advantageously split telemetry collection into chunks of components that are smaller than collecting these data for all components in the remote device at once. Embodiments further advantageously schedule these collections when the device is predicted to be least loaded. Embodiments also advantageously derive the telemetry collection times by accounting for the present state of each remote device, as opposed to the prior art approach of making collections only on a fixed (periodic) basis or during emergencies, and group collections into chunks by accounting for the length of time necessary to perform collection for each component.

Thus, a first embodiment is a method of collecting performance data from a plurality of electronic devices. The method includes receiving a selection of one or more of the electronic devices in the plurality of electronic devices. The method next includes using a machine learning model to predict a future workload, as a function of time, of each of the selected electronic devices. The method also includes performing a regression analysis to predict, for each component that is found in the selected one or more electronic devices, a duration required to collect performance data that pertains to the component. The method calls for determining both (a) an idle period of each of the selected one or more electronic devices, and (b) respective components of each of the selected one or more electronic devices, whose entire performance data can be collected within the idle period, wherein determining is a function of the predicted future workload of each electronic device and the predicted duration required to collect performance data that pertain to each component. The method continues with collecting, as a batch from each of the selected one or more electronic devices during its idle period, performance data that pertain to the respective components.

In some embodiments, using the machine learning model to predict a future workload comprises applying linear time series forecasting to historical workload data for an electronic device that is most similar to a selected electronic device.

In some embodiments, when the selected electronic device shares a configuration with another electronic device for which historical workload data are available, the method includes determining the electronic device that is most similar to the selected electronic device to be the other electronic device.

In some embodiments, when the selected electronic device does not share a configuration with another electronic device for which historical workload data are available, the method includes determining the electronic device that is most similar to the selected electronic device by computing cosine similarity between components of the selected electronic device and components of electronic devices for which historical workload data are available.

In some embodiments, performing the regression analysis comprises using a multiple linear regression.

In some embodiments, determining the idle period of a selected electronic device comprises identifying an earliest idle period in which the entire performance data of any component is collectible by the selected electronic device, and determining the respective component of the selected electronic device comprises identifying a component whose entire performance data is collectible by the selected electronic device during the determined idle period.

Some embodiments include using a machine learning model to determine a priority order in which to collect performance data from components of a selected electronic device.

In some embodiments, using the machine learning model to determine the priority order comprises using a k-nearest neighbors model.

Some embodiments include collecting, from each of the selected electronic devices during its idle period, performance data for several components at once, wherein the several components are determined according to the priority order, the predicted future workload of the respective electronic device, and the predicted durations required to collect performance data for each of the components.

In some embodiments, collecting performance data from a selected electronic device comprises, when a remaining idle duration is insufficient to collect the entire performance data of a component having a highest remaining priority according to the priority order, collecting the entire performance data of a component having a lower remaining priority according to the priority order.

Another embodiment is a non-transitory computer-readable storage medium in which is stored computer program code for using a computing processor to perform the above method or any of its variations.

It is appreciated that the concepts, techniques, and structures disclosed herein may be embodied in other ways, and that the above summary of disclosed embodiments is thus meant to be illustrative rather than comprehensive or limiting.

### DESCRIPTION OF THE SEVERAL VIEWS OF THE DRAWINGS

The manner and process of making and using the disclosed embodiments may be appreciated by reference to the drawings, in which:

FIG. 1 schematically shows a managed environment which is adaptable to accommodate an embodiment of the concepts, techniques, and structures disclosed herein;

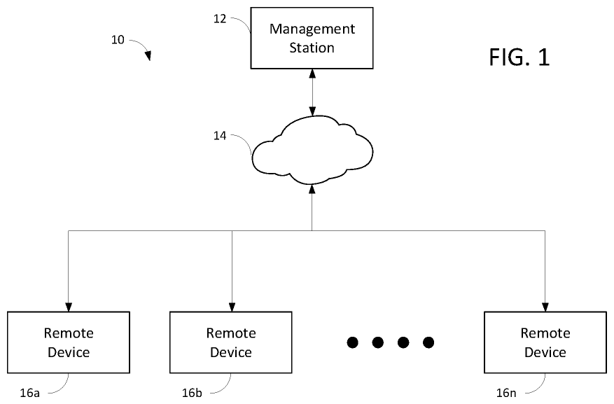

FIG. 2 schematically shows relevant components of a system for collecting performance data from a plurality of electronic devices according to an embodiment;

FIG. 3 is a flow diagram for a method of collecting performance data from a plurality of electronic devices according to an embodiment; and

FIG. 4 schematically shows relevant physical components of a computer that may be used to embody the concepts, structures, and techniques disclosed herein.

### DETAILED DESCRIPTION OF EMBODIMENTS

Embodiments of the concepts, techniques, and structures disclosed herein improve upon the prior art by intelligently scheduling collection of state information from managed devices by predicting future workloads of those devices, and predicting how long it will take to collect state information from each component of the devices. Embodiments then may match predicted idle times of each device with component state data collections, thereby avoiding adding additional load to the device during times of high activity. Moreover, when idle times from many devices overlap, information may be gathered from all of these devices at once. A heavy workload on any particular device does not delay collection of state information from other devices. Thus, by contrast with the prior art, embodiments are better at providing accurate, timely telemetry.

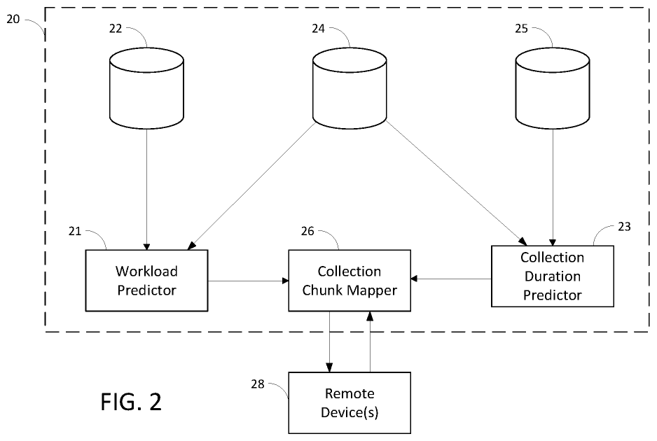

In this connection, in FIG. 2 is schematically shown relevant functional components of a system 20 for collecting performance data from a plurality of remote electronic devices 28 according to an embodiment. The system 20, and/or each of its functional components, may be implemented as hardware (e.g. as an application-specific integrated circuit, or ASIC) or as a combination of hardware and software (e.g. as a software program executing on a device management station, such as management station 12). After reading the description of its functional components, a person having ordinary skill in the art should understand how to implement the system 20 in either of these configurations, or using similar technologies, without undue experimentation.

The system 20 has six main components: a workload predictor 21, a workload history database 22, a collection duration predictor 23, a device configuration database 24, a collection history database 25, and a collection chunk mapper 26. The workload history database 22, the configuration database 24, and the collection history database 25 may be implemented using any database technology known in the art, and contain data as explained in detail below. Although

FIG. 2 shows three separate databases 22, 24, and 25, it is appreciated that these databases may be implemented as portions of a single database, for example using different database tables, and are shown separately only for simplicity of explanation. The remaining components are now described in turn.

The workload predictor 21 predicts the workload of remote devices (e.g. remote devices 16) by analyzing the historical performance of the remote devices and configuration information of the remote devices for a given period, e.g. the last 365 days. Historical performance of the remote devices may be represented, for example, as time series data indicating various metrics that are relevant to respective components of the remote devices, and stored in the workload history database 22 using techniques known in the art.

Components of a server device may include, without limitation: a battery, a virtual or logical disk, an enclosure, a controller, a fan, a central processing unit (CPU), a network interface, a power supply, a supplied voltage, a memory, and so on. These components are described for each managed device in the configuration database 24. It is appreciated that other devices, such as networking hardware and storage arrays, have other components; a person having ordinary skill in the art will understand how to adapt the disclosure herein to these other components.

Moreover, each component of a remote device has one or more relevant performance metrics that may be measured. Thus, a relevant metric for a central processing unit (CPU) of a remote device may be its percentage utilization; other components have a variety of other relevant performance metrics. The historical performance of each such component (i.e., values representing its performance metrics) may be stored in workload history database 22 in association with their collection times.

The workload predictor 21 uses a machine learning model to predict a future workload, as a function of time, of each of a collection of electronic devices. The future workload of a device may be represented, for example, as a sequence of pairs of a future time with a predicted duration of relative device inactivity or idleness. Thus, the future workload for a given device might be indicated as idle at 1:00 am for 15 seconds, idle at 1:30 am for 55 seconds, idle at 2:30 am for 120 seconds, idle at 3:30 am for 400 seconds, and so on. These times and durations are merely illustrative, and practical embodiments may represent predicted device idle times using other formats, with other frequencies, and with other units of measurement.

To predict the future workload for a particular device, the workload predictor 21 may apply linear time series forecasting to historical workload data stored in the workload history database 22 to predict each relevant performance metric for the device components over a future period, e.g. the next 24 hours. Suitable time series forecasting algorithms are known in the art. Such algorithms may forecast time series data based on an additive model, where non-linear trends are fit with yearly, weekly, and daily seasonality, plus holiday effects, may be robust to missing data and shifts in the trend, and may be designed to handle outliers well. A person having ordinary skill in the art will understand how to choose an algorithm suited to a particular managed environment.

Consider, for example, an electronic device having a CPU, memory, and network interface (e.g. a firewall). The device may be associated with several performance metrics, including CPU utilization, device bandwidth, device input/output (I/O) working set, and device I/O bytes per second, among others. These data may be collected over time in an initialization phase, and stored as a time series in the workload history database 22. After sufficient data have been collected, the embodiment may enter an operational phase. During operation, the workload predictor 21 obtains configuration information about the particular device from the configuration database 24, then analyzes the historical data for each of the device components using the chosen forecasting algorithm, and finally models the predicted behavior of each of those metrics in the electronic device over the next 24 hours. Based on the predicted behavior of each metric, the workload predictor 21 determines how the individual metrics interact (e.g. by summing their values according to an appropriate formula to obtain an overall predicted workload), and this analysis identifies durations in which the remote device is predicted have low overall workload, or equivalently a period of relative idleness. In accordance with embodiments, these durations of low workload or idleness are useful for collecting state information without interfering with the other functions of the remote device.

If a particular device has been deployed for long enough to train the machine learning algorithm on its past workloads, then predicting its future workloads should be performed by analyzing its own past performance data. Otherwise, the prediction should be based on analyzing historical workload data for an electronic device that is most similar to a selected electronic device.

In practical managed environments, the workload predictor 21 may be called upon to predict workloads for devices having a wide variety of configurations. In some cases, when a selected electronic device exactly shares a configuration with another deployed electronic device for which historical workload data are available in sufficient quantities, then the electronic device that is most similar to a selected electronic device (for purposes of applying machine learning) is simply that other electronic device. That is, embodiments predict the future workload on a particular device by analyzing historical workload data of another device having the same configuration.

In some situations, however, the workload predictor 21 must predict the future workload of a device that does not share a configuration with any other device for which sufficient historical workload data are available to apply the machine learning algorithm. In this case, the workload predictor 21 basis its prediction on historical data of another device having the most similar, i.e. closest configuration. While several techniques exist for determining what “closest” means in this context, embodiments disclosed herein preferentially may use the technique of cosine similarity. That is, embodiments compute cosine similarity between components of the selected electronic device, and components of electronic devices for which sufficient historical workload data are available in the workload history database 22.

Cosine similarity is a measure of similarity that exists between two devices in an environment. It enables ranking of devices with respect to configuration information of a given device. Suppose one uses the vector x=(x₁, x₂, . . . , xₙ) to describe the numbers or sizes of various components of the given device. Thus, x₁ may represent a number of CPUs possessed by any device, x₂ may represent the size of its volatile memory, x₃ may represent a maximum I/O rate, and so on. Such a vector may be formed for each electronic device in the environment, and each such vector exists in an n-dimensional configuration space. Then the configurations of devices may be compared by computing the notional angle between their representational vectors. The closer this angle is to zero (or equivalently, the closer the cosine of this angle is to one), the more similar are the two device configurations. Thus, the following formula for the cosine is used to measure cosine similarity:

$$sim ( x , y ) = \frac{x * y}{‖ x ‖ ‖ y}$$

where x*y is the dot product of the vectors x and y that represent different devices, with formula x₁y₁+x₂y₂+ . . . +xₙyₙ, and ∥x∥ is the Euclidean norm (length) of the vector x, with formula \sqrt{x₁²+x₂²+ . . . +xₙ².} If the computed cosine similarity value for two devices is close to 1 then the two devices are quite similar, and the workload predictor 21 may use the historical workload data of one device to predict the future workload of the other.

The collection duration predictor 23 predicts the time required to collect the telemetry information from each component of each remote device. Prediction of collection times is based on detection of the device configuration, and on analysis of the historical collection time for each component of the remote device. Device configuration information is stored in the configuration database 24 described above, while historical collection times for the various components are stored in the collection history database 25. Thus, for example, a device having 7 components may have respective performance data collection durations of 30 seconds, 60 seconds, 45 seconds, 20 seconds, 60 seconds, 70 seconds, and 15 seconds. These durations are merely illustrative, and embodiments may be used with devices have any number of components with any respective collection durations.

Predicting a duration required to collect performance data from each component of each remote device may be performed using a regression analysis on all components. It has been found that multiple linear regression is particularly useful in this context. In embodiments, the collection time for each component or section of the collection is determined using multiple linear regression by the formula y=β₀+β₁x₁+β₂x₂+ . . . βₚxₚ+ϵ, where y is the predicted collection time of a component or section, β₀ is a time that represents a constant processing overhead to perform the collection, each xᵢ is the collection time for a respective component of the device, each βᵢ is the corresponding number of components, and ϵ is an error term. By way of illustration, the required time predicted for collecting telemetry information for an entire server can be computed as the sum “(no. of fans)×(time taken for collection from each fan)+(no. of hard-drives)×(time taken for collection from each hard-drive)+(no. of processors)×(time taken for collection from each processor) + . . . ”, where the sum continues to include each component on the server.

The collection chunk mapper 26 combines the idle times predicted by the workload predictor 21 with the durations to collect telemetry information from each component of a selected remote device predicted by the collection duration predictor 23. Based on the combination, the collection chunk mapper 26 first determines an idle period of the selected electronic device, and an initial component whose entire performance data can be collected within the idle period. The collection chunk mapper 26 next prioritizes the related or affected components from which telemetry information must be collected, and finally triggers telemetry collections from the components according to the priority order.

The first process performed by the collection chunk mapper 26 is determining, for a selected remote device, the component whose performance data should be collected first. The selection of the remote device (or a collection of such devices) may be made, for example, directly by an IT administrator using a device management station. Alternately, the selection may be made on a least-recently-queried basis, or using some other criteria that may be apparent to a person having ordinary skill in the art. The selection of the component whose performance data should be collected first may be made as a function of the predicted idle time. That is, the collection chunk mapper 26 may choose, for initial collection, any component whose entire performance data is collectible by the selected remote device during the next predicted idle period. For instance, if the next predicted idle period lasts 30 seconds, the collection chunk mapper 26 may choose, for initial collection during that idle period, a component whose performance data may be collected in any duration less than (or equal to) 30 seconds.

Next, to determine the priority or order of other components for collecting telemetry information, the collection chunk mapper 26 uses extended machine learning. The collection chunk mapper 26 builds a relevance tree whose root is the first selected component, branching outward with the nearest nodes most relevant to the first component and the farthest nodes the least relevant to the first component. For example, if the first component from which the telemetry information is collected is a fan, then the next most relevant component may be the temperature sensors for the fan, as they are physically near the fan and could be most affected because of the heat resulting from the fan during a malfunction. Similarly, if the first component is a CPU, the next most relevant component may be its heat sink.

To classify the other components that are relevant or non-relevant to the first component from which the telemetry information was collected, embodiments use the k-nearest neighbors (KNN) supervised machine learning algorithm. When an outcome is required for a new data instance, the KNN algorithm searches the entire data set (placing of components within devices, mean time between failure of components, heat resistance, etc.) to find the k-nearest instances to the new instance, i.e. the number k of instances most similar to the new record, and then outputs the mode (most frequent classification) for these instances. The value of the number k may be user-specified. The similarity between instances may be calculated using Hamming distance, or other methods known in the art.

After the relevance of each of the components have been classified and their proximal distances to the first component (and in some embodiments, each other) have been calculated, a tree or other data structure is generated to capture the hierarchy of relevance, and then the collection chunk mapper 26 triggers collection of telemetry information from the remote devices 28 in order of proximity to the root node (i.e., the first component).

To improve efficiency of data collection, performance data for several components are collected at once whenever possible, where the several components are determined according to the priority order, the predicted future workload of the respective electronic device, and the predicted durations required to collect performance data for each of the components. That is, the collection chunk mapper 26 produces “chunks” of components for each remote device to poll at once during a given idle period. Concretely, after each component is added to a chunk for a given idle period, its predicted collection duration is subtracted from the time available, with the highest priority components selected first. However, when a remaining idle duration is insufficient to collect the entire performance data of a component having a highest remaining priority according to the priority order, the collection chunk mapper 26 may choose instead to collect the entire performance data of a component having a lower remaining priority according to the priority order (if such a component exists). Thus, if the next predicted idle period lasts 30 seconds, and the performance data for the first component may be collected in only 15 seconds, then the collection chunk mapper 26 fills the remaining 15 seconds with collection of data for other components that can fit that window, in decreasing priority order.

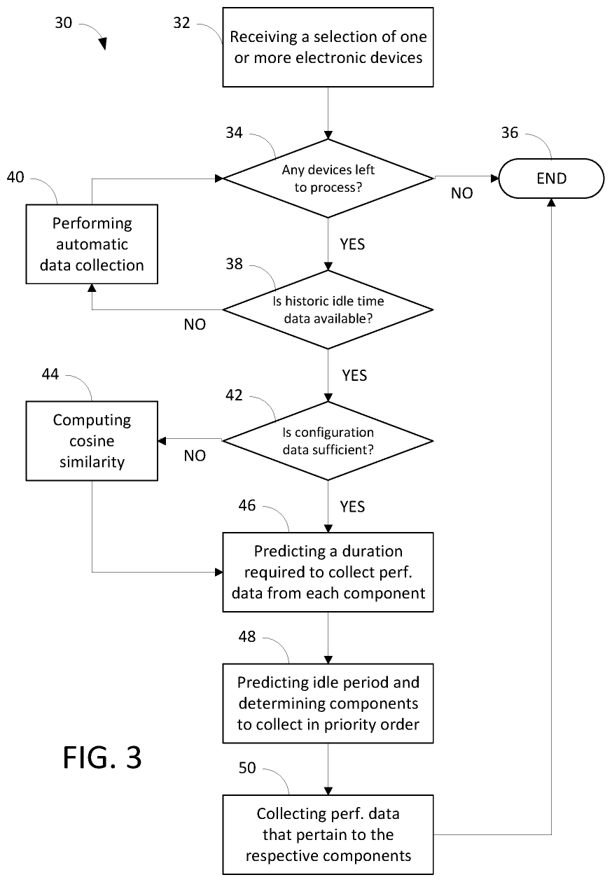

In FIG. 3 is shown a flow diagram for a method 30 of collecting performance data from a plurality of electronic devices according to an embodiment. As shown in FIG. 3, periodic collections are triggered by the device management and monitoring application in batches. Thus, the method 30 begins with a first process 32 of receiving a selection of one or more electronic devices (e.g. from the IT administrator) from which to obtain performance data.

Next, the method 30 enters a loop to collect the data from each selected device in the batch. Thus, the method 30 determines in a process 34 whether there are any remote devices in the batch left to process, i.e. devices from which periodic telemetry information has not been collected. If there are no more such devices, then the loop has ended and the method 30 concludes in process 36. However, if at least one device was selected, the method 30 will proceed.

If there are remote devices pending collection, the method 30 chooses the next device from the batch and determines in a process 38 whether workload or idle time information is available for that device (e.g. from a database such as workload database 22). If workload prediction or idle time information is not available, the method 30 triggers a process 40 performing automatic collection of telemetry information from the device, irrespective of its workload. That is, if the data necessary to implement the concepts and techniques described herein are not available, then collection of performance data falls back on traditional, prior art techniques.

If, however, the workload prediction or idle time information is available, the method 30 proceeds to a process 42 that determines if the data are sufficient to perform analysis of the historical data by considering the device configuration information. If the required configuration information of the remote device is not available, the method 30 must perform an extra process 44 of computing cosine similarity to determine the closest matching device configuration that can be used, as described above.

If the configuration data is sufficient, or once a close enough matching device configuration has been found, the method 30 moves to a process 46 of predicting a duration required to collect performance data from each component of the device, as described above in connection with the collection duration predictor 23. The method then invokes a process 48 of predicting a next idle period for the device, as described above in connection with the workload predictor 21, and determining components to collect performance data in priority order, as described above in collection with the collection chunk mapper 26.

Finally, with the available remote device workload information and device configuration information, the method 30 triggers a process 50 of collecting telemetry (performance) data from each component of the remote device based on the available idle times and the priority order, as described above in connection with the collection chunk mapper 26. The method 30 collects chunks of telemetry information at various intervals based on the idle time of the remote device, and chunks are merged together to form the complete periodic telemetry collection of the remote device.

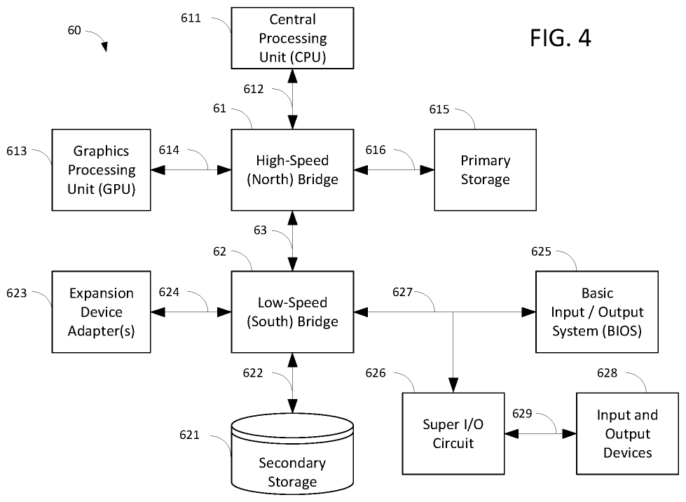

FIG. 4 schematically shows relevant physical components of a computer 60 that may be used to embody the concepts, structures, and techniques disclosed herein. In particular, the computer 60 may be used to implement, in whole or in part, the system 20 for collecting performance data or the method 30 of collecting performance data. Generally, the computer 60 has many functional components that communicate data with each other using data buses. The functional components of FIG. 4 are physically arranged based on the speed at which each must operate, and the technology used to communicate data using buses at the necessary speeds to permit such operation.

Thus, the computer 60 is arranged as high-speed components and buses 611 to 616 and low-speed components and buses 621 to 629. The high-speed components and buses 611 to 616 are coupled for data communication using a high-speed bridge 61, also called a “northbridge,” while the low-speed components and buses 621 to 629 are coupled using a low-speed bridge 62, also called a “southbridge.”

The computer 60 includes a central processing unit (“CPU”) 611 coupled to the high-speed bridge 61 via a bus 612. The CPU 611 is electronic circuitry that carries out the instructions of a computer program. As is known in the art, the CPU 611 may be implemented as a microprocessor; that is, as an integrated circuit (“IC”; also called a “chip” or “microchip”).

In some embodiments, the CPU 611 may be implemented as a microcontroller for embedded applications, or according to other embodiments known in the art.

The bus 612 may be implemented using any technology known in the art for interconnection of CPUs (or more particularly, of microprocessors). For example, the bus 612 may be implemented using the HyperTransport architecture developed initially by AMD, the Intel QuickPath Interconnect (“QPI”), or a similar technology. In some embodiments, the functions of the high-speed bridge 61 may be implemented in whole or in part by the CPU 611, obviating the need for the bus 612.

The computer 60 includes one or more graphics processing units (GPUs) 613 coupled to the high-speed bridge 61 via a graphics bus 614. Each GPU 613 is designed to process commands from the CPU 611 into image data for display on a display screen (not shown). In some embodiments, the CPU 611 performs graphics processing directly, obviating the need for a separate GPU 613 and graphics bus 614. In other embodiments, a GPU 613 is physically embodied as an integrated circuit separate from the CPU 611 and may be physically detachable from the computer 60 if embodied on an expansion card, such as a video card. The GPU 613 may store image data (or other data, if the GPU 613 is used as an auxiliary computing processor) in a graphics buffer.

The graphics bus 614 may be implemented using any technology known in the art for data communication between a CPU and a GPU. For example, the graphics bus 614 may be implemented using the Peripheral Component Interconnect Express (“PCI Express” or “PCIe”) standard, or a similar technology.

The computer 60 includes a primary storage 615 coupled to the high-speed bridge 61 via a memory bus 616. The primary storage 615, which may be called “main memory” or simply “memory” herein, includes computer program instructions, data, or both, for use by the CPU 611. The primary storage 615 may include random-access memory (“RAM”). RAM is “volatile” if its data are lost when power is removed, and “non-volatile” if its data are retained without applied power. Typically, volatile RAM is used when the computer 60 is “awake” and executing a program, and when the computer 60 is temporarily “asleep”, while non-volatile RAM (“NVRAM”) is used when the computer 60 is “hibernating”; however, embodiments may vary. Volatile RAM may be, for example, dynamic (“DRAM”), synchronous (“SDRAM”), and double-data rate (“DDR SDRAM”). Non-volatile RAM may be, for example, solid-state flash memory. RAM may be physically provided as one or more dual in-line memory modules (“DIMMs”), or other, similar technology known in the art.

The memory bus 616 may be implemented using any technology known in the art for data communication between a CPU and a primary storage. The memory bus 616 may comprise an address bus for electrically indicating a storage address, and a data bus for transmitting program instructions and data to, and receiving them from, the primary storage 615. For example, if data are stored and retrieved 64 bits (eight bytes) at a time, then the data bus has a width of 64 bits. Continuing this example, if the address bus has a width of 32 bits, then 2³² memory addresses are accessible, so the computer 60 may use up to 8*2³²=32 gigabytes (GB) of primary storage 615. In this example, the memory bus 616 will have a total width of 64+32=96 bits. The computer 60 also may include a memory controller circuit (not shown) that converts electrical signals received from the memory bus 616 to electrical signals expected by physical pins in the primary storage 615, and vice versa.

Computer memory may be hierarchically organized based on a tradeoff between memory response time and memory size, so depictions and references herein to types of memory as being in certain physical locations are for illustration only. Thus, some embodiments (e.g. embedded systems) provide the CPU 611, the graphics processing units 613, the primary storage 615, and the high-speed bridge 61, or any combination thereof, as a single integrated circuit. In such embodiments, buses 612, 614, 616 may form part of the same integrated circuit and need not be physically separate. Other designs for the computer 60 may embody the functions of the CPU 611, graphics processing units 613, and the primary storage 615 in different configurations, obviating the need for one or more of the buses 612, 614, 616.

The depiction of the high-speed bridge 61 coupled to the CPU 611, GPU 613, and primary storage 615 is merely exemplary, as other components may be coupled for communication with the high-speed bridge 61. For example, a network interface controller (“NIC” or “network adapter”) may be coupled to the high-speed bridge 61, for transmitting and receiving data using a data channel. The NIC may store data to be transmitted to, and received from, the data channel in a network data buffer.

The high-speed bridge 61 is coupled for data communication with the low-speed bridge 62 using an internal data bus 63. Control circuitry (not shown) may be required for transmitting and receiving data at different speeds. The internal data bus 63 may be implemented using the Intel Direct Media Interface (“DMI”) or a similar technology.

The computer 60 includes a secondary storage 621 coupled to the low-speed bridge 62 via a storage bus 622. The secondary storage 621, which may be called “auxiliary memory”, “auxiliary storage”, or “external memory” herein, stores program instructions and data for access at relatively low speeds and over relatively long durations. Since such durations may include removal of power from the computer 60, the secondary storage 621 may include non-volatile memory (which may or may not be randomly accessible).

Non-volatile memory may comprise solid-state memory having no moving parts, for example a flash drive or solid-state drive. Alternately, non-volatile memory may comprise a moving disc or tape for storing data and an apparatus for reading (and possibly writing) the data.

Data may be stored (and possibly rewritten) optically, for example on a compact disc (“CD”), digital video disc (“DVD”), or Blu-ray disc (“BD”), or magnetically, for example on a disc in a hard disk drive (“HDD”) or a floppy disk, or on a digital audio tape (“DAT”). Non-volatile memory may be, for example, read-only (“ROM”), write-once read-many (“WORM”), programmable (“PROM”), erasable (“EPROM”), or electrically erasable (“EEPROM”).

The storage bus 622 may be implemented using any technology known in the art for data communication between a CPU and a secondary storage and may include a host adaptor (not shown) for adapting electrical signals from the low-speed bridge 62 to a format expected by physical pins on the secondary storage 621, and vice versa. For example, the storage bus 622 may use a Universal Serial Bus (“USB”) standard; a Serial AT Attachment (“SATA”) standard; a

Parallel AT Attachment (“PATA”) standard such as Integrated Drive Electronics (“IDE”), Enhanced IDE (“EIDE”), ATA Packet Interface (“ATAPI”), or Ultra ATA; a Small Computer System Interface (“SCSI”) standard; or a similar technology.

The computer 60 also includes one or more expansion device adapters 623 coupled to the low-speed bridge 62 via a respective one or more expansion buses 624. Each expansion device adapter 623 permits the computer 60 to communicate with expansion devices (not shown) that provide additional functionality. Such additional functionality may be provided on a separate, removable expansion card, for example an additional graphics card, network card, host adaptor, or specialized processing card.

Each expansion bus 624 may be implemented using any technology known in the art for data communication between a CPU and an expansion device adapter. For example, the expansion bus 624 may transmit and receive electrical signals using a Peripheral Component Interconnect (“PCI”) standard, a data networking standard such as an Ethernet standard, or a similar technology.

The computer 60 includes a basic input/output system (“BIOS”) 625 and a Super I/O circuit 626 coupled to the low-speed bridge 62 via a bus 627. The BIOS 625 is a non-volatile memory used to initialize the hardware of the computer 60 during the power-on process. The

Super I/O circuit 626 is an integrated circuit that combines input and output (“I/O”) interfaces for low-speed input and output devices 628, such as a serial mouse and a keyboard. In some embodiments, BIOS functionality is incorporated in the Super I/O circuit 626 directly, obviating the need for a separate BIOS 625.

The bus 627 may be implemented using any technology known in the art for data communication between a CPU, a BIOS (if present), and a Super I/O circuit. For example, the bus 627 may be implemented using a Low Pin Count (“LPC”) bus, an Industry Standard Architecture (“ISA”) bus, or similar technology. The Super I/O circuit 626 is coupled to the I/O devices 628 via one or more buses 629. The buses 629 may be serial buses, parallel buses, other buses known in the art, or a combination of these, depending on the type of I/O devices 628 coupled to the computer 60.

In the foregoing detailed description, various features of embodiments are grouped together in one or more individual embodiments for the purpose of streamlining the disclosure. This method of disclosure is not to be interpreted as reflecting an intention that the claims require more features than are expressly recited therein. Rather, inventive aspects may lie in less than all features of each disclosed embodiment.

Having described implementations which serve to illustrate various concepts, structures, and techniques which are the subject of this disclosure, it will now become apparent to those of ordinary skill in the art that other implementations incorporating these concepts, structures, and techniques may be used. Accordingly, it is submitted that that scope of the patent should not be limited to the described implementations but rather should be limited only by the spirit and scope of the following claims.

What is claimed is:

1. A method of collecting performance data from a plurality of electronic devices, the method comprising:
receiving a selection of one or more of the electronic devices in the plurality of electronic devices;
using a machine learning model to predict a future workload, as a function of time, of each of the selected electronic devices;
performing a regression analysis to predict, for each component that is found in the selected one or more electronic devices, a duration required to collect performance data that pertains to the component;
determining both (a) an idle period of each of the selected one or more electronic devices, and (b) respective components of each of the selected one or more electronic devices, whose entire performance data can be collected within the idle period, wherein determining is a function of the predicted future workload of each electronic device and the predicted duration required to collect performance data that pertain to each component; and
collecting, as a batch from each of the selected one or more electronic devices during its idle period, performance data that pertain to the respective components.

2. The method of claim 1, wherein using the machine learning model to predict a future workload comprises applying linear time series forecasting to historical workload data for an electronic device that is most similar to a selected electronic device.

3. The method of claim 2, further comprising:
when the selected electronic device shares a configuration with another electronic device for which historical workload data are available, determining the electronic device that is most similar to the selected electronic device to be the other electronic device.

4. The method of claim 2, further comprising:
when the selected electronic device does not share a configuration with another electronic device for which historical workload data are available, determining the electronic device that is most similar to the selected electronic device by computing cosine similarity between components of the selected electronic device and components of electronic devices for which historical workload data are available.

5. The method of claim 1, wherein performing the regression analysis comprises using a multiple linear regression.

6. The method of claim 1, wherein determining the idle period of a selected electronic device comprises identifying an earliest idle period in which the entire performance data of any component is collectible by the selected electronic device, and determining the respective component of the selected electronic device comprises identifying a component whose entire performance data is collectible by the selected electronic device during the determined idle period.

7. The method of claim 1, further comprising using a machine learning model to determine a priority order in which to collect performance data from components of a selected electronic device.

8. The method of claim 7, wherein using the machine learning model to determine the priority order comprises using a k-nearest neighbors model.

9. The method of claim 7, further comprising collecting, from each of the selected electronic devices during its idle period, performance data for several components at once, wherein the several components are determined according to the priority order, the predicted future workload of the respective electronic device, and the predicted durations required to collect performance data for each of the components.

10. The method of claim 9, wherein collecting performance data from a selected electronic device comprises, when a remaining idle duration is insufficient to collect the entire performance data of a component having a highest remaining priority according to the priority order, collecting the entire performance data of a component having a lower remaining priority according to the priority order.

11. A non-transitory computer-readable storage medium in which is stored computer program code for using a computing processor to perform a method of collecting performance data from a plurality of electronic devices, the method comprising:
receiving a selection of one or more of the electronic devices in the plurality of electronic devices;
using a machine learning model to predict a future workload, as a function of time, of each of the selected electronic devices;
performing a regression analysis to predict, for each component that is found in the selected one or more electronic devices, a duration required to collect performance data that pertains to the component;
determining both (a) an idle period of each of the selected one or more electronic devices, and (b) respective components of each of the selected one or more electronic devices, whose entire performance data can be collected within the idle period, wherein determining is a function of the predicted future workload of each electronic device and the predicted duration required to collect performance data that pertain to each component; and
collecting, as a batch from each of the selected one or more electronic devices during its idle period, performance data that pertain to the respective components.

12. The storage medium of claim 11, wherein the program code for using the machine learning model to predict a future workload comprises program code for applying linear time series forecasting to historical workload data for an electronic device that is most similar to a selected electronic device.

13. The storage medium of claim 12, further comprising program code for:
when the selected electronic device shares a configuration with another electronic device for which historical workload data are available, determining the electronic device that is most similar to the selected electronic device to be the other electronic device.

14. The storage medium of claim 12, further comprising program code for:
when the selected electronic device does not share a configuration with another electronic device for which historical workload data are available, determining the electronic device that is most similar to the selected electronic device by computing cosine similarity between components of the selected electronic device and components of electronic devices for which historical workload data are available.

15. The storage medium of claim 11, wherein the program code for performing the regression analysis comprises program code for using a multiple linear regression.

16. The storage medium of claim 11, wherein the program code for determining the idle period of a selected electronic device comprises program code for identifying an earliest idle period in which the entire performance data of any component is collectible by a selected electronic device, and the program code for determining the respective component of the selected electronic device comprises program code for identifying a component whose entire performance data is collectible by the selected electronic device during the determined idle period.

17. The storage medium of claim 11, further comprising program code for using a machine learning model to determine a priority order in which to collect performance data from components of a selected electronic device.

18. The storage medium of claim 17, wherein the program code for using the machine learning model to determine the priority order comprises program code for using a k-nearest neighbors model.

19. The storage medium of claim 17, further comprising program code for collecting, from each of the selected electronic devices during its idle period, performance data for several components at once, wherein the several components are determined according to the priority order, the predicted future workload of the respective electronic device, and the predicted durations required to collect performance data for each of the components.

20. The storage medium of claim 19, wherein the program code for collecting performance data from a selected electronic device comprises, when a remaining idle duration is insufficient to collect the entire performance data of a component having a highest remaining priority according to the priority order, program code for collecting the entire performance data of a component having a lower remaining priority according to the priority order.
